(19) United States
(12) Patent Application Publication
(10) Pub. No.: US 2008/0263646 A1
(43) Pub. Date: Oct. 23, 2008

(54) SYSTEMS AND METHODS FOR A COMPUTER NETWORK SECURITY SYSTEM USING DYNAMICALLY GENERATED PASSWORDS

(76) Inventor: Edgar C. Jerez, Salt Lake City, UT (US)

Correspondence Address: TRASK BRITT, P.O. BOX 2550, SALT LAKE CITY, UT, 84110, US

(21) Appl. No.: 11/760,589

(22) Filed: Jun. 8, 2007

Related U.S. Application Data
(63) Continuation-in-part of application No. 11/736,794, filed on Apr. 18, 2007.

(51) Int. Cl. G06F 21/22

(52) U.S. Cl. 726/6

(57) ABSTRACT

Methods and systems for a computer network security system are disclosed. A computer security system includes at least one computer configured to be operably coupled to a remote network and having an application program comprising a login scripts database and a variable database. The security system further includes a client device configured to be operably coupled to the computer to allow for the use of the application program. The application program is configured to dynamically generate a password upon attempting to access a remote network. Furthermore, the application program may update passwords within a user's login scripts database. Additionally, a remote network may support the security system and may include at least one computer system having an administrator application program installed thereon and configured to receive a network device and an administrator device. A network administrator may use the network and administrator device to monitor and modify contents of the security system.

### RELATED APPLICATIONS

This application is a continuation-in-part of U.S. patent application Ser. No. 11/736,794 entitled SYSTEMS AND METHODS FOR A COMPUTER NETWORK SECURITY SYSTEM USING DYNAMICALLY GENERATED PASSWORDS filed Apr. 18, 2007, the disclosure of which is hereby incorporated by reference.

### FIELD OF THE INVENTION

The present invention, in various embodiments, relates generally to a computer security system and, more specifically, to a security system for generating and managing computer network passwords.

### BACKGROUND OF THE INVENTION

In the last decade, the use of personal computers in both the home and in the workplace has become widespread. In addition, personal computers have been instrumental in the emergence of the internet and its use as a medium of commerce. Computer networks, such as the internet, have become very popular for accessing private and sensitive information from a remote location as well as carrying out transactions that require user authentication. For example, with online banking it is possible for a banking customer to login to his bank account to view balances and make certain transactions from his home or office. While beneficial, the growing use of computers in personal communications, commerce, and business has also given rise to a number of unique challenges. For example, traditional forms of network security are no longer sufficient to ensure that only authorized users or paying subscribers are able to gain access to secured networks.

Currently, there is great demand for authenticating the identity of an individual before granting that person access to a secured network and potentially sensitive information. The use of user identification in conjunction with passwords or personal identification numbers (PIN) is one mechanism for protecting access to personal or private data or services that require some form of authentication. Traditionally, a username and password is entered by a user in some type of text box and thereafter transmitted to an authentication server.

One conventional authentication solution used in computer and network security consists of a data-on-host solution. The user data, such as a password, is stored in the host application. FIG. 1 is a schematic illustration of the data-on-host class of solution in which the user login credentials such as a user ID and a password are kept on the host computer 101. A user may use a standard web browser 103 to connect to the login page of a remote merchant server 105 over a network 104. A specialized application 107 monitors the communication data flowing between the browser 103 and the remote server 105 and automatically fills in the username and password data in the login form by reading this data from a data repository 109 on the host computer 101. The repository 109 can either be a file on the host computer 101 or can be kept inside the system registry database of the host computer 101. Storing confidential information, such as a password, on a host application may expose the host computer to an intrusion or a break-in by a hacker or another person with access to the host computer.

Another conventional authentication system consists of a data-on-external-token solution that stores data on a conventional external device, such as a smart card, but still requires a host application to transfer this data to the remote server. FIG. 2 is a schematic illustration of this solution wherein the user login data 209 is not kept on the host computer 201 from which the user is connecting, but on an external hardware token 207 (e.g., a conventional smart card). As before, the web browser 103 is a standard web browser through which a user connects to the login page of a remote server 105. An application 107′ monitors the communication data between the browser 103 and the server 105 and inserts the username and password into login form. The application 107′ reads the login data 209 from the smart card 207. Although this solution increases security, it requires a remote server to be modified so that it can accept login credentials from a smart card.

While very simple to implement, use of user identification in conjunction with passwords or personal identification numbers creates serious security concerns in addition to the shortcomings mentioned above. Conventionally, passwords selected by users are too simple, not changed with the appropriate frequency, and are not stored in a safe place. As a result, it is relatively easy for hackers to obtain a user's password and access a secured network. Other conventional security systems such as firewalls and Demilitarized Zones (DMZ) include simple passwords and may be easily accessed by hackers.

There is a need for methods, systems, and devices to enhance the security of computers and computer networks. Specifically, there is a need for providing a computer security system that may dynamically generate a more complicated password, manage the password in a secure manner, and allow login to a remote server without modification to the remote server.

### BRIEF SUMMARY OF THE INVENTION

An embodiment of the invention includes a method of operating a computer network security system. The system includes coupling a first device to a computer and providing a client application program, a first database, and a second database stored on the first device, the computer, a server within a device management entity, or combinations thereof. The method further includes enabling the client application by completing an authentication process while the first device is coupled to the computer. Additionally, the method includes selecting a login entry from the first database, wherein the login entry comprises a password generation schema. The method also includes generating a dynamic password, wherein the dynamic password is generated using the password generation schema and a plurality of variables within the second database. Finally, the method includes logging into a remote host using the dynamic password.

Another embodiment of the invention includes a computer security system. The computer security system includes at least one computer configured to be operably coupled to a remote network. The computer security system further includes at least one client application program, a first database, and a second database stored on a first client device, the computer, a server within a device management entity, or combinations thereof. The at least one client application program is configured to dynamically generate a password. In addition, the computer security system includes the at least one client device configured to be operably coupled to the at least one computer. Additionally, the at least one client device is further configured to enable use of the at least one client application program upon completion of an authentication process. Finally, the computer security system includes at least one computer system within the remote network and configured to receive a username and password from the at least one computer.

Another embodiment of the invention includes a computer network security system. The computer network security system includes at least one computer configured to be operably coupled to a remote network. The computer network security system further includes at least one client application program, a first database, and a second database stored on a first client device, the computer, a server within a device management entity, or combinations thereof. The at least one client application program is configured to dynamically generate a password. The method also includes the at least one client device configured to be operably coupled to the at least one computer. The at least one client device is further configured to enable use of the at least one client application program upon completion of an authentication process. Additionally, the computer network security system includes at least one computer system within the remote network and configured to receive a username and password from the at least one client application program. The at least one computer system of the plurality comprises an administrator application program stored thereon and including a plurality of databases. Furthermore, the computer network security system includes a second device configured to be operably coupled to the at least one computer system and configured to allow for the monitoring of the at least one device, first database, the second database, the plurality of databases, and any communication links between the at least one client application program and the administrator application program. Finally, the computer network security system includes a third device configured to be operably coupled to the at least one computer system and configured to allow for modification of the at least one device, the second device, the first database, the second database, and the plurality of databases.

Another embodiment of the invention comprises a method of generating a password. The method includes selecting an entry from a database and selecting randomly a plurality of characters from the entry. The method further includes modifying at least one selected character of the plurality and generating at least a portion of a password from the plurality of selected characters.

Another embodiment of the invention comprises a computer-readable media storing instructions that when executed by a processor cause the processor to perform instructions for generating a password according to an embodiment of the invention.

### BRIEF DESCRIPTION OF THE DRAWINGS

In the drawings:

FIG. 1 is a block diagram of a conventional data-on-host computer security solution;

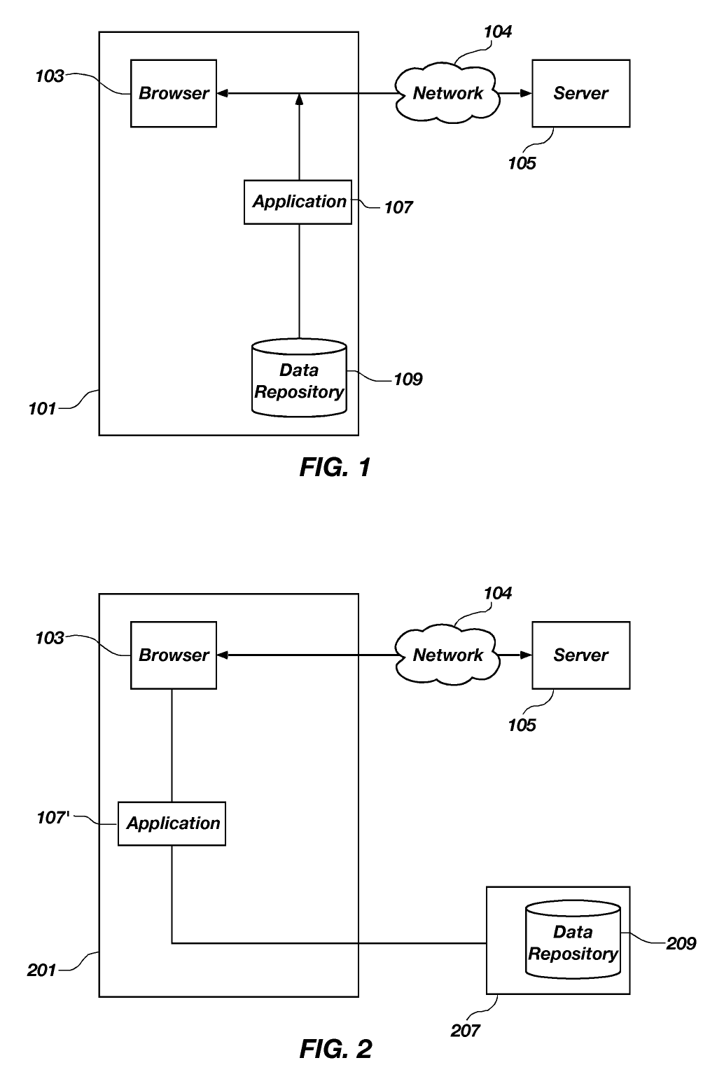

FIG. 2 is a block diagram of a conventional data-on-external-token computer security solution;

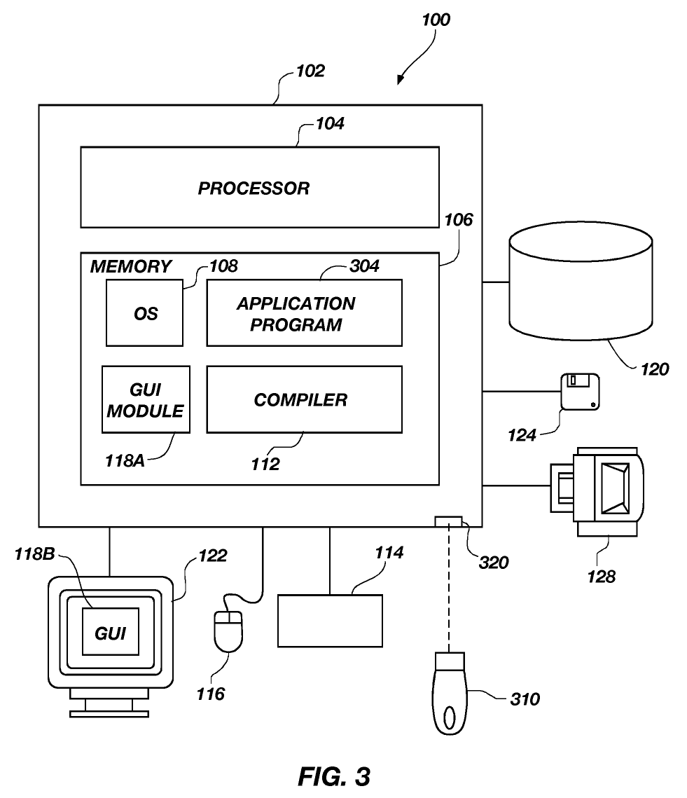

FIG. 3 is a block diagram illustrating a hardware environment according to an embodiment of the invention;

FIG. 4 is a block diagram of a computer security system network including an external device in accordance with an embodiment of the invention;

FIG. 5 is a screen shot of a login entry according to an embodiment of the invention;

FIG. 6 is a screen shot of a login page in accordance with an embodiment of the invention;

FIG. 7 is a block diagram of a computer security system network including external and internal devices in accordance with an embodiment of the invention;

FIG. 8 is a block diagram of a computer security system network including a network and administrator device application in accordance with an embodiment of the invention; and

FIGS. 9(a), (b), and (c) illustrate examples of network topologies supported by embodiments of the invention.

### DETAILED DESCRIPTION OF THE INVENTION

The present invention, in various embodiments, comprises methods, systems, and devices of a network and computer security system for generation, management and protection of user passwords.

Referring in general to the accompanying drawings, various embodiments of the present invention are illustrated to show the structure and methods for a computer network security system. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the invention.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

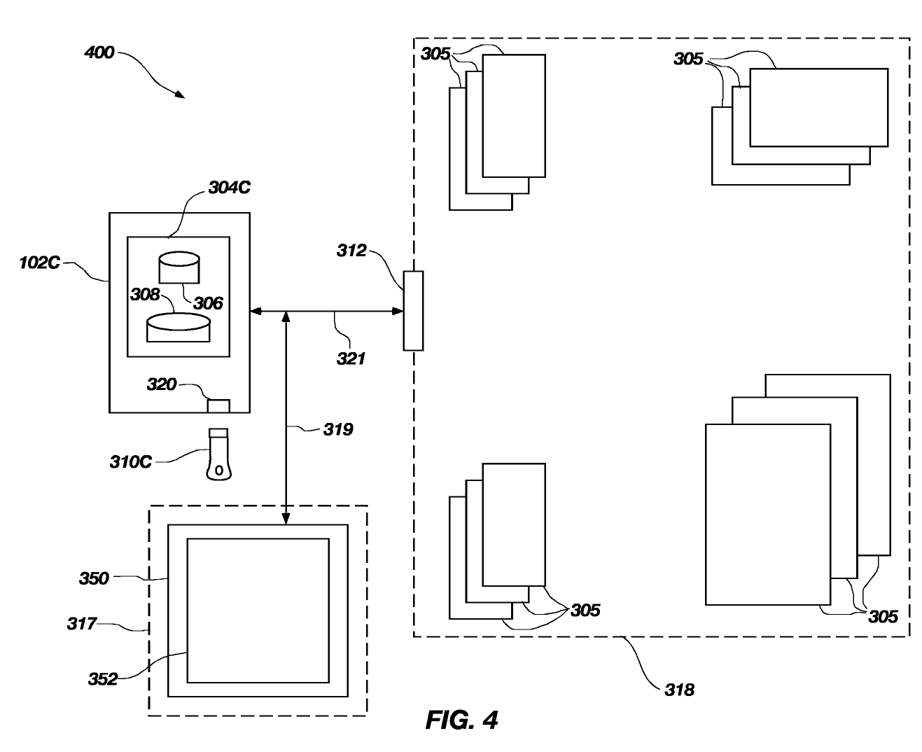

FIG. 3 illustrates a computer system 100 that may be used to implement embodiments of the present invention. Computer system 100 may include a computer 102 that comprises a processor 104 and a memory 106, such as random access memory (RAM) 106. For example only, and not by way of limitation, computer 102 may comprise a workstation, a laptop, or a hand held device such as a cell phone or a personal digital assistant (PDA) or any other processor-based device known in the art. Computer 102 may be operably coupled to a display 122, which presents images, such as windows, to the user on a graphical user interface 118B. Computer 102 may be operably coupled to other devices, such as a keyboard 114, a mouse 116, a printer 128, etc.

Generally, computer 102 may operate under control of an operating system 108 stored in the memory 106, and interface with a user to accept inputs and commands and to present outputs through a graphical user interface (GUI) module 118A. Although the GUI module 118A is depicted as a separate module, the instructions performing the GUI functions may be resident or distributed in the operating system 108, an application program 304, or implemented with special purpose memory and processors. Computer 102 may also implement a compiler 112 which allows an application program 304 written in a programming language to be translated into processor 104 readable code. After completion, application program 304 may access and manipulate data stored in the memory 106 of the computer 102 using the relationships and logic that are generated using the compiler 112. Computer 102 may also comprise at least one input/output (I/O) port 320 for a personal token 310 (hereinafter referred to as a device 310). Device 310, as described in greater detail below, may comprise a client device 310C, a network device 310N, or an administrator device 310A. For example only, device 310 may include a Universal Serial Bus (USB) interface and I/O port 320 may comprise a USB-compliant port implementing a USB-compliant interface. In another embodiment of the invention, I/O port 320 may be implemented as a wireless interface. In such an embodiment, device 310 may include, for example only, a wireless device with wireless technology, Bluetooth® technology, Wi-Fi technology, or WiMAX technology to provide for communication between device 310 and computer 102. For example only, and not by limitation, device 310 may include a cellular telephone, a USB drive, a personal digital assistant (PDA), or a portable media player or any combination thereof. Cellular telephones, in addition to conventional cellular telephones, may include, for example, voice over internet protocol (VOIP) phones or an iPhone manufactured by Apple Computer, Inc., of Cupertino, Calif.

In one embodiment, instructions implementing the operating system 108, application program 304, and compiler 112 may be tangibly embodied in a computer-readable medium, e.g., data storage device 120, which may include one or more fixed or removable data storage devices, such as a zip drive, floppy disc drive 124, hard drive, CD-ROM drive, tape drive, flash memory device, etc. Further, the operating system 108 and the application program 304 may include instructions which, when read and executed by the computer 102, may cause the computer 102 to perform the steps necessary to implement and/or use embodiments of the present invention. Application program 304 and/or operating instructions may also be tangibly embodied in memory 106 and/or data communications devices, thereby making a computer program product or article of manufacture according to an embodiment the invention. As such, the term “application program” as used herein is intended to encompass a computer program accessible from any computer readable device or media. Furthermore, portions of the application program may be distributed such that some of the application program may be included on a computer readable media within the computer, some of the application program may included in the device 310, and some of the application program may be included in a remote computer, as will be explained more fully below.

Those skilled in the art will recognize that many modifications may be made to this configuration without departing from the scope of the present invention. For example, those skilled in the art will recognize that any combination of the above components, or any number of different components, peripherals, and other devices, may be used with the present invention.

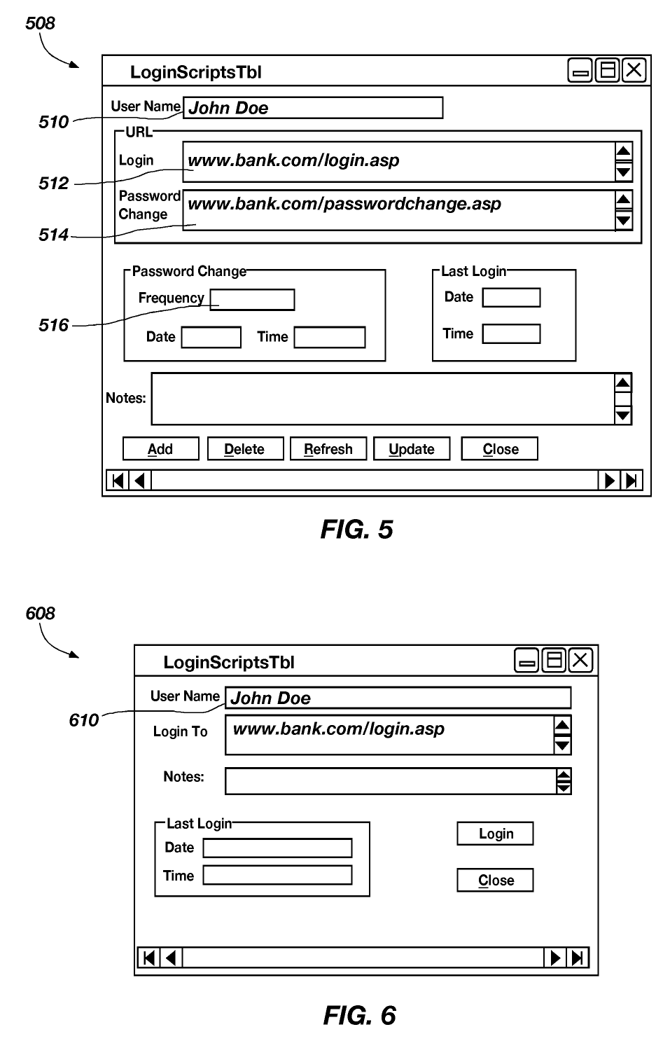

FIG. 4 illustrates a computer network utilizing a security system 400 including an external client computer 102C and client device 310C external to a network 318, in accordance with an embodiment of the invention. For example, the system 400 depicted in FIG. 4 may represent a security system used by an individual attempting to run client application program 304C and, thereafter, attempting to establish a connection to a remote host via the internet and a secured network. For explanation purposes only, and not by way of limitation, the remote host may include an online banking system and the client device user may be attempting to access an online bank account. Furthermore, this example entails using a conventional online banking system wherein a bank server does not provide support for security system 400 and a client device user (i.e., the bank account owner), upon attempting to access an account, may be asked to provide a user name and password.

External client computer 102C may include at least one input/output (I/O) device port 320 configured to receive a client device 310C. Client device 310C may be configured to be used by a single individual user on a stand-alone client computer. Additionally, client device 310C may be assigned a Globally Unique Identifier (GUID) in order to ensure that the ownership of client device 310C is assigned to an individual client user. Furthermore, external client computer 102C may be operably coupled to networks 317/318 via communication links 319/321, respectively. Networks 317/318 may include a firewall 312 configured to permit, deny or proxy data connections set and configured by the network's security policy. For example only, networks 317/318 may comprise a Local Area Network (LAN) or a Wide Area Network (WAN), such as the internet. Communication link 319/321 may comprise any form of wireless or wired connections or any combination thereof. External client computer 102C may implement an internet browser, allowing a client user to access the World Wide Web (WWW) and other internet resources.

External client computer 102C may include client application program 304C stored thereon and comprising a login scripts database 306 and a variable database 308. Login scripts database 306 may include at least one login entry corresponding to a remote host that a device user wishes to access, such as an online banking system. Variable database 308 may include at least one dictionary, wherein each dictionary may comprise multiple entries such as, but not limited to, words, numbers, and pictures. Dictionaries may be used for, as described below, dynamically generating a password. For example only, the dictionary may comprise over one thousand entries. Dictionaries within variable database 308 may be updated and/or generated on a desired basis by client application program 304C.

Network 317 may include a device management entity 350 configured to provide support and/or services to a client device user. In addition to being stored within external client computer 102C, a device user's login scripts database 306 and variable database 308 may be stored on a server 352 within device management entity 350. In an embodiment where a client device user attempts to run an application program from a computer not including an application program, the device user may run an application program and access the user's login scripts database and variable database through device management entity 350. Therefore, it is not necessary for external client computer 102C to include client application program 304C, login scripts database 306 or a variable database 308. In an embodiment where a client device user is using a computer with an application program installed therein, such as external client computer 102C, device management entity 350 may update the dictionaries stored within variable database 308. Furthermore, device management entity 350 may generate additional dictionaries and, thereafter, a client device user may download additional dictionaries from device management entity 350 into variable database 308. Network 318 may include at least one computer system 305. For example only, and not by way of limitation, computer system 305 may comprise workstations, laptops, servers, mainframe computers or any other processor-based device known in the art.

For explanation purposes only, a possible operation of the security system 400 depicted in FIG. 4 will now be described. Upon connecting external client device 310C to device port 320, client application program 304C and a client device user may proceed through an authentication process in order to allow the client device user to access client application program 304C. It should be noted that a client device user may not run client application program 304C unless client device 310C is connected to client computer 102C and the authentication process has been completed. The authentication process may vary depending on whether client device 310C is configured to operate in a local mode or a global mode.

In local mode operation, client device 310C may be configured to operate only on one specified computer. If client device 310C is programmed to operate in local mode, client application program 304C may, upon connection of client device 310C, perform a software serialization process wherein the GUID assigned to the client device 310C may be linked with client application program 304C to ensure that the ownership of client device 310C and client application program 304C are assigned to the same user. Additionally, the authentication process may require the client device user to enter a key sequence such as, but not limited to, a user identification (ID), a password, or a personal pin. In another embodiment, a client device user may be required to provide a fingerprint in order to satisfy the authentication process.

In global mode operation, client device 310C may be configured to operate on more than one computer and, therefore, a client device user may perform desired operations from any computer. If client device 310C is programmed to operate in global mode, an external client computer may not be required to include an application program and, therefore, device management entity 350 may transmit a GUID and/or a one time password to a client device user via an electronic device such as, but not limited to, a cellular telephone. Using the GUID and/or the one time password, a client device user may subsequently attempt to run a remote application program and access the user's login scripts database and variable database on server 352.

If a client device user fails to complete the authentication process, the client device user may be denied access to client application program 304C and, therefore, will not be able to access login scripts database 306 or login to a remote site. Furthermore, client device 310C may be configured to disable upon a specified number of unsuccessful authentication attempts. Upon disablement, notice of a possible stolen device may be transmitted to the client device user or the device management entity 350.

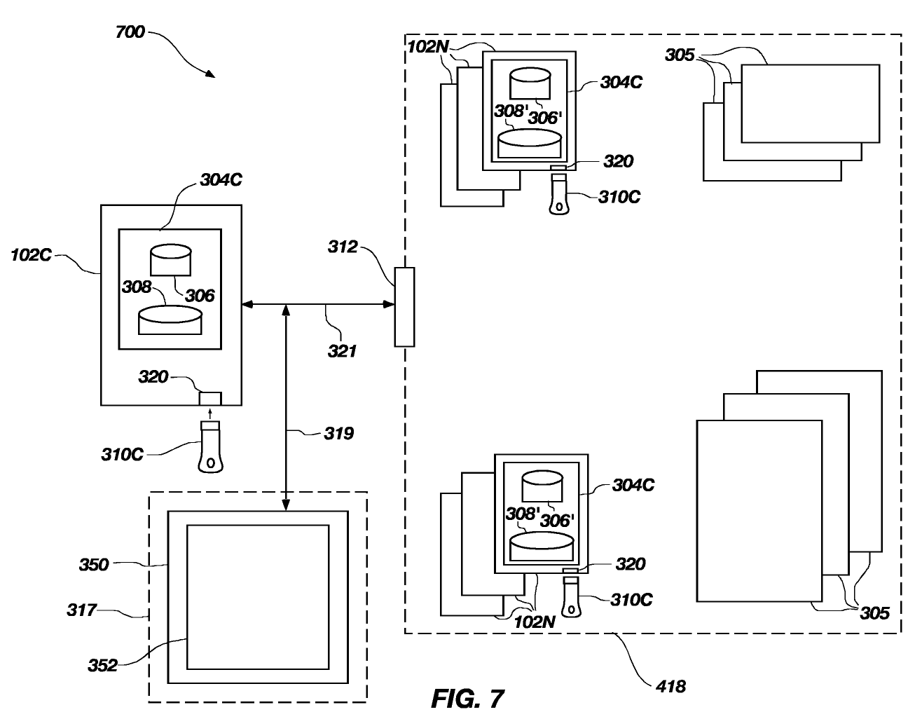

If the authentication process has been successfully completed, a client device user may access client application program 304C and may be provided with several options such as, but not limited to, modifying the authentication method, accessing the login scripts database, or logging into a remote site. Upon choosing to access the login scripts database, a client device user may, for example, add a login entry, edit a login entry, or delete a login entry from the login scripts database 306. As illustrated in the screen shot login entry page depicted in FIG. 5, a login entry page 508 may include a prompt for a user name 510, a prompt for a Uniform Resource Locator (URL) address of a login page of a remote site 512, and a prompt for a URL of the address of remote site to set or change a user's password 514. In addition, a login entry may include a prompt for a frequency 516 stipulating how often the password should be changed (i.e., the frequency of password change). Using the bank example, if a device user wishes to have a new password generated for the user's bank account login generated once a day, the user may enter this within the login entry page pertaining to the online bank account and client application program 304C will automatically update the device user's account password once a day. As such, the options within a login entry may be configured as desired by a client device user. A login entry may also include a password generation schema as set by the client device user. As described in greater detail below, a password generation schema may include a process of generating a password wherein a device user may select options to be included within the password generation schema. As such, each login entry may include a different password generation schema and, therefore, a different method of creating a password.

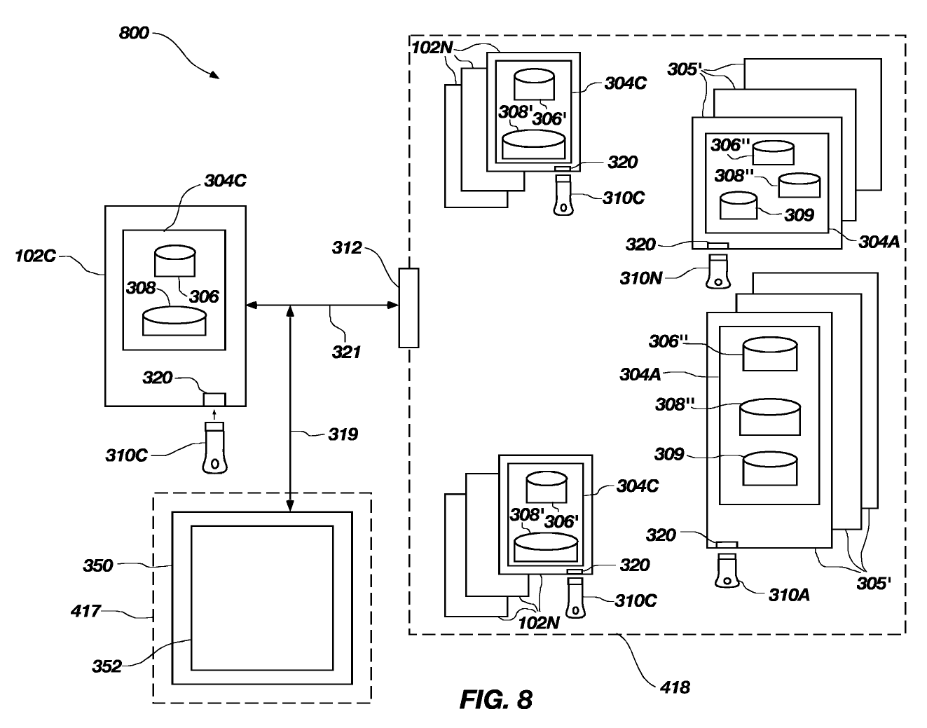

In attempting to login to a remote host, (e.g., the bank's server) a client device user may select an appropriate login entry (e.g., the login entry for the bank) from the login scripts database 306. Subsequently, client application program 304C, will load the corresponding login page 608, as illustrated in FIG. 6. Login page 608 may include a user name within the appropriate user name prompt 610. As described in greater detail below, client application program 304C may then dynamically generate a password. Thereafter, the client device user may submit the login screen with the dynamic password and a remote host login will be attempted. It should be noted that client device 310C may communicate with any conventional login screen (i.e., the Bank's login screen) and may operate independent of whether a remote host (i.e., the Bank's server) supports security system 400.

A password may be dynamically generated by client application program 304C using a password generation schema and multiple variables such as, but not limited to, a user identification (ID), a local password, current date, current time, or any other variables within a dictionary and selected by a client device user. The password generation schema may comprise a process wherein a number of entries (i.e., ten words) are chosen from a dictionary stored within variable database 308. A number of characters (i.e., six characters) may then be selected from each chosen entry. The selected characters may be further modified by a bit manipulation process in order to scramble the selected characters and provide further protection. The bit manipulation process may include performing at least one bit operation on the selected characters. The bit operations may include, but are not limited to, shift operators and bitwise operators (i.e., “shift left n bits,” “circular shift left n bits,” “XOR with a mask,” etc.). After modifying the selected characters, the characters may be used to generate a password. The generated password is never visible to the client device user and is never stored within external client computer 102C, but rather is dynamically generated when a device user activates a login entry.

For explanation purposes only, an example of the password generation process will now be described. A first entry may be chosen from the dictionary. Subsequently, a number of characters may be randomly chosen from the first entry. The chosen characters from the first entry may then be modified by the manipulation process. After modification, the chosen, modified characters from the first entry may be used to generate a first portion of a password. Thereafter, a second entry may be chosen from the dictionary, and a number of characters may be randomly chosen from the second entry. The chosen characters from the second entry may then be modified by the manipulation process. After modification, the chosen, modified characters from the second entry may be added to the password. This process may be repeated as desired to generate a final password. For example only, and not limitation, the password generation schema may generate a password comprising up to 64-characters.

Referring again to FIG. 4, after a client device user submits the login page including the user name and dynamically generated password, computer system 305 may receive the user name and password and subsequently compare the received information with a user name and password stored within computer system 305 pertaining to the client device user. If the submitted user name and password match the stored user name and password within computer system 305, the client device user may access the user's account.

In a conventional login system, in order to change a user's password, a user must provide his current password and the new password to a remote host. In an embodiment of the invention, client application program 304 may update a password pertaining to a remote host by accessing the URL of the remote host that allows for the modification of a user's password. The current password will first be generated by the current password generation schema stored within the corresponding login entry pertaining to the remote host. Thereafter, the password generation schema will be updated by client application program 304C, and a new password will be then be generated by the new password generation schema. Client application program 304C may then submit the current dynamically generated password along with a new dynamically generated password to the remote host and, therefore, a client device user's password may be updated.

For added security, if a client device 310C remains in external client computer 102C during a specific period of non-use, client device 310C may deactivate itself and may be reactivated only by re-plugging client device 310C into the corresponding external client computer 102C and successfully completing the authentication process. Furthermore, if a client device 310 is reported lost or stolen, device management entity 350 may disable the client device 310C upon request of the client device user. Thereafter, a new client device may be assigned to the user and all login scripts may be accessible by the new client device.

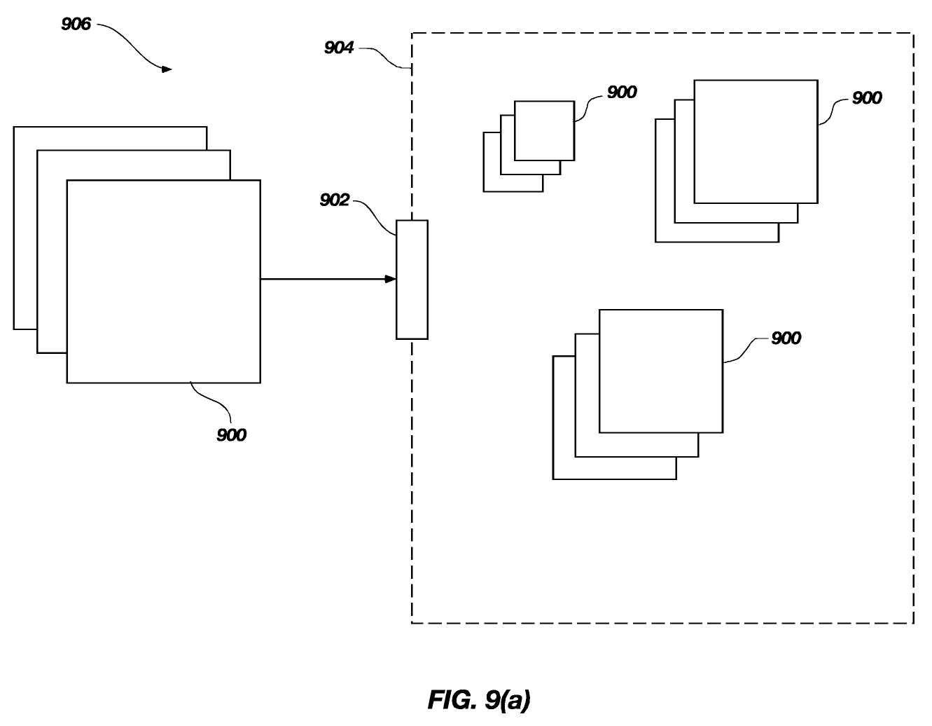

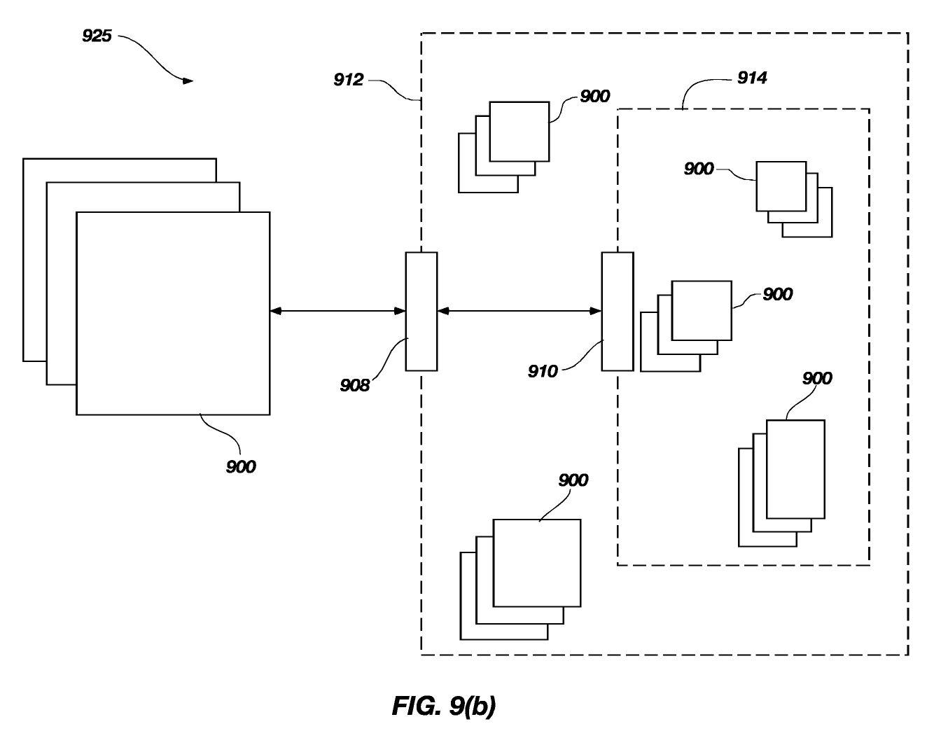

FIG. 7 illustrates a security system 700 including client devices 310C operating within, and external to, network 418. For explanation purposes only, and not by way of limitation, the network configurations illustrated in FIGS. 7 and 8 may represent a security system used by a company to provide for security involving the company's network and use of the network by employees of the company. FIG. 7 may illustrate a configuration wherein client devices 310C may be used to ensure that only company employees are allowed access to the company's computer network. FIG. 8 may illustrate a configuration including network device 310N and administrator device 310A used to ensure that all client computers (i.e., computers used by employees) and remote login systems associated with a company computer network follow the standards set by the company for the generation, alteration, and maintenance of user IDs and passwords. In both examples, employees of the company may have a client device 310C and may not be allowed to login to the company's network unless the employee's client device is plugged into a client computer and the employee had successfully completed an authentication process.

Referring to FIG. 7, external client computer 102C may be operably coupled to a network 418 via communication link 321. Network 418 may include a firewall 312 configured to permit, deny or proxy data connections set and configured by the network's security policy. By way of example only, network 418 may comprise a LAN (i.e., a company's network). Network 418 may include internal client computers 102N and computer systems 305. The above description of FIG. 4 relating to external client computer 102C, client application program 304C, client device 310C, and device management entity 350 is applicable to internal client computers 102N, client application program 304C, and device management entity 350 illustrated in FIGS. 7 and 8. As such, internal client computer 102N may include a client application program 304C, login scripts database 306′, and variable database 308′.

After connecting client device 310C to client computer 102C/102N and successfully completing an authentication process as described above, a client device user external to the network (i.e., using external client computer 102C) may attempt to remotely login to network 418 through the internet using client device 310C. In addition, a client device user within network 418 (i.e., using internal client computer 102N) may attempt login to the network 418 using client device 3 10C. To complete the login process, a client device user may proceed through a similar process as described above in reference to FIG. 4. Therefore, a client device user, using client computer 102C/102N, may load a login entry page 508 (see FIG. 5) corresponding to the company's network and the corresponding client device 310C may dynamically generate a password, as described above. After a client device user submits the login page including the user name and dynamically generated password, computer system 305 may receive the user name and password and subsequently compare the received information with a user name and password stored within computer system 305 pertaining to the client device user. If the submitted user name and password match the stored user name and password within computer system 305, a device user may access network 418. The generated password is never visible to a client device user and is never stored within client computer 102C/102N, but rather is dynamically generated when a device user activates a login entry.

FIG. 8 illustrates a security system 800 including a network device and administrator device application according to an embodiment of the invention. In addition to providing security support to client device users attempting to access a remote or local server, FIG. 8 illustrates a security system 800 that provides for support on a remote host, such as network 418. The above description regarding client computers 102C/102N in FIGS. 4 and 7 similarly applies to FIG. 8. In addition, computer systems 305′ may each include an administrator application program 304A installed thereon and comprising a login scripts database 306″, variable database 308″, and a user's database 309. Administrator application program 304A may differ from client application program 304C in that administrator application program 304A may be configured to be used with a network device 310N and/or an administrator device 310A. Furthermore, administrator application program 304A may be configured to be monitored and modified by a network administrator.

User's database 309 may include information pertaining to each client device user who may have access to network 418. Information stored pertaining to each client device user within user's database may include, for example only, the GUID assigned to a user's client device 310C, a user's password generation schema, a dictionary ID assigned to the user, a desired frequency of password change, and a date and time of last login. In addition, a user's database may include a login time range, such as a user's work schedule (i.e., 8:00 AM-5:00 PM).

Variable database 308″ may include at least one dictionary, each dictionary comprising multiple entries such as, but not limited to, words, numbers, and pictures. Variables within variable database 308″ may be set by a network administrator. Dictionaries within variable database 308″ may be updated and/or generated by administrator application program 304A. In addition, administrator application program 304A may update dictionaries stored within variable databases 308/308′ on client computers 102C/102N. Furthermore, device management entity 350 may generate additional dictionaries and, subsequently, upload dictionaries into variable databases 308/308′/308″. Additionally, device management entity 350 and administrator application program 304A may generate and maintain multiple dictionaries, potentially a different dictionary for every client device user within network 418. As such, a client device user may download additional dictionaries from computer system 305′ or device management entity 350.

Computer systems 305′ may also include at least one input/output (I/O) device port 320 configured to receive a network device 310N and/or an administrator's device 310A. In one embodiment, administrator application program 304A may be stored on network device 310N or administrator device 310A. As described above, network device 310N and administrator's device 310A may each include, for example only, a wireless device with wireless technology, Bluetooth® technology, Wi-Fi technology, or WiMAX technology to provide for communication between device 310 and computer system 305′. Network device 310N and administrator device 310A may be configured to operate simultaneously on the same computer system 305′ or on separate computer systems 305′. Network device 310N maybe configured to operate continuously while the corresponding computer system 305′ is in a powered-on state. Furthermore, network device 310N may be configured to allow for the monitoring of multiple client device users, external and internal client devices 310C/310N, and any external networks (not shown). Additionally, network device 310N may be configured to monitor logins of all client users, the contents of variable database 308/308′/308″, the contents of user's database 309, and the contents of login scripts database 306/306′/306″ including each client user's passwords and password generation schema. For example, a network device 310N may ensure that all passwords of employees using client devices 310C connected to the company network are updated once a day, once a week, etc. Furthermore, network device 3 10N may be configured to monitor all communication links connected to network 418 so as to prevent session hijacking. For example, session hijacking, as known in the art, may be prevented by sending a client device user a message, such as an email or text message, querying whether a specific request was made by the client device user.

Similar to the method described above in reference to a client device user and client device 310C, a network administrator may insert an administrator's device 310N into a computer system 305′ and proceed through an authentication process. Upon successful authentication, an administrator's device 310A may allow a network administrator to modify the settings of application program 304C/304A, client devices 310C, network device 310N, variable database 308/308′/308″, user's database 309, and login scripts database 306/306′/306″ including each client device user's passwords and password generation schema. Administrator device 310A may also allow a network administrator to add and delete system users to a network.

As mentioned above in reference to FIG. 4, client device 310C may be configured to disable upon a specified number of unsuccessful authentication attempts. Upon disablement, notice of a possible stolen device may be transmitted to the client device user, device management entity 350, or a network administrator. For added security, if administrator device 310A remains in computer system 305′ during a specific period of non-use, administrator device 310A may deactivate itself. Administrator device 310A may then only be reactivated by a network administrator re-plugging the administrator device 310A into computer system 305′ and subsequently completing the authentication process described above. Furthermore, if administrator device 310A is reported lost or stolen, device management entity 350 may disable administrator device 310A upon request of the network administrator.

For explanation purposes only, a possible operation of security system 800 will now be described. After plugging client device 310 into client computer 102C/102N, a device user may complete an authentication process, as described above, and, thereafter, client application program 304C may be started. While running client application program 304C, a client device user may be provided with several options such as, but not limited to, modifying the authentication method, accessing the login scripts database, or logging into a remote site. Upon choosing to access the login scripts database, a client device user may, for example, add a login entry, edit a login entry, or delete a login entry from the login scripts database 306.

Upon choosing to login to a remote host, (i.e., the company's network) a client device user may select an appropriate login entry (i.e., the login entry for the company) from the login scripts database 306. Subsequently, client application program 304C, will load the corresponding login page. As described above, client application program 304C may then dynamically generate a password. Thereafter, the client device user may submit the login screen with the dynamic password and a remote host login will be attempted.

After a device user submits the login page including the user name and dynamically generated password, administrator application program 304A may access the device user's password generation schema within user's database 309 and the user's password may be dynamically generated within administrator application program 304A. Subsequently, administrator application program 304A may compare the user name and password received from client application program 304C with the user name and password generated within administrator application program 304A. If both user names and passwords match, a device user may access network 418. As such, the generated password is never visible to a client device user and is never stored within client computer 102C/102N or computer system 305′, but rather is dynamically generated by both client application program 304C and administrator application program 304A when a device user activates a login entry.

As described above, client application program 304C may update a password pertaining to a remote host by accessing the URL of the remote host allowing for modification of a user's password. Furthermore, security system 800 allows for administrator application program 304A to update the passwords of all client device users within network 418. To update a client device user's password, administrator application program 304A may access the login entry within a client device user's login scripts database 306/306′ pertaining to network 418. Thereafter, administrator application program 304A may update the password generation schema linked with network 418 and the updated password generation schema will be stored within the client device user's login scripts database 306/306′ and user's database 309. As a result, the client device user's password generation schema pertaining to network 418 has been updated and upon a subsequent attempt to login to network 418, the dynamically generated password will be recognized by administrator application program 304A.

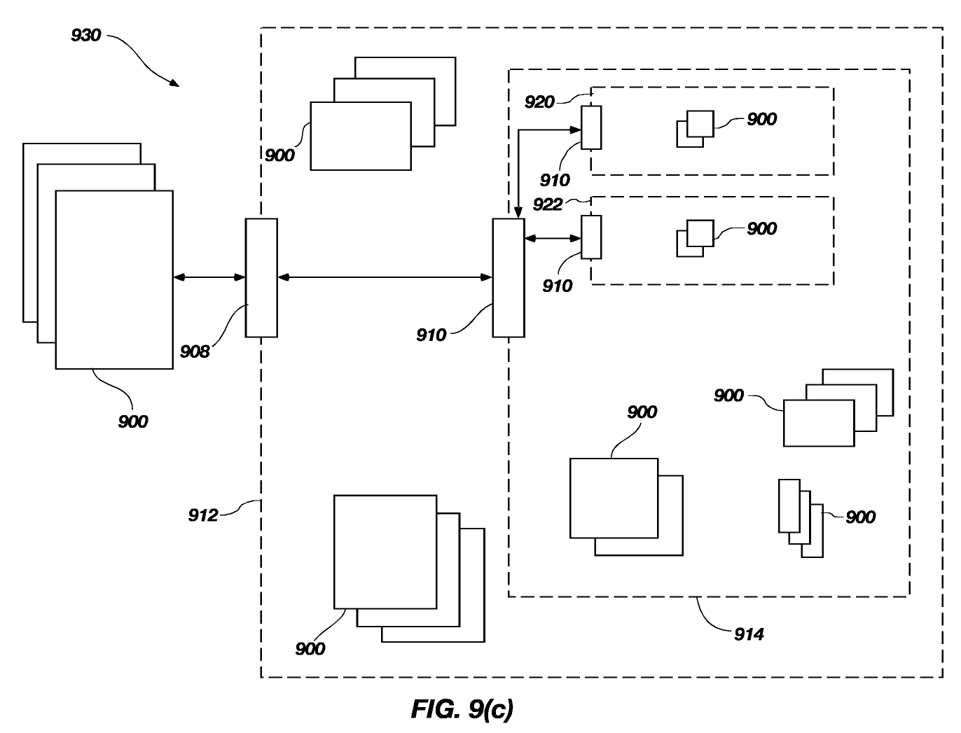

FIGS. 9(a), (b), and (c) illustrate examples of network topologies supported by security systems 400, 700, and 800 described above. The network topologies are used only for example, and by no means limit any embodiment of the invention. FIG. 9(a) illustrates a single file network 906 comprising one or more computers 900 external and operably coupled to private network 904. Network 904 comprises a firewall 902 and may include one or more computers 900. FIG. 9(b) illustrates a double firewall network 925. Double firewall network 925 may include one or more computers 900 external and operably coupled to a DMZ 912 through an outer firewall 908. Computers 900 may also be included within DMZ 912. Double firewall network 925 may also include a private network 914 comprising an inner firewall 910 and one or more computers 900. FIG. 9(c) illustrates an internal security and DMZ network 930. Internal security and DMZ network 930 may include one or more computers 900 external and operably coupled to a DMZ 912 through an outer firewall 908. Computers 900 may also be included within DMZ 912. Internal security and DMZ network 930 may also include a private network 914 comprising an inner firewall 910 and one or more computers 900. Private network 914 may also include at least one private sub-network 920/922. For example, private sub-networks 920/922 may comprise an internal human resources network or an internal engineering network. Each sub-networks 920/922 may includes one or more computer 900.

Specific embodiments have been shown by way of example in the drawings and have been described in detail herein; however, the invention may be susceptible to various modifications and alternative forms. It should be understood that the invention is not intended to be limited to the particular forms disclosed. Rather, the invention includes all modifications, equivalents, and alternatives falling within the spirit and scope of the invention as defined by the following appended claims.

What is claimed is:

1. A method of operating a computer network security system, comprising:
coupling a first device to a computer;
providing a client application program, a first database, and a second database stored on the first device, the computer, a server within a device management entity, or combinations thereof;
enabling the client application program by completing an authentication process while the first device is coupled to the computer;
selecting a login entry from the first database, wherein the login entry comprises a password generation schema;
generating a dynamic password, wherein the dynamic password is generated using the password generation schema and a plurality of variables within the second database; and
logging into a remote host using the dynamic password.

2. The method of claim 1, wherein coupling a first device to a computer comprise coupling a wireless device to a computer with at least one of a wireless technology, a Bluetooth® technology, a Wi-Fi technology, and a WiMAX technology.

3. The method of claim 2, wherein coupling a wireless device to a computer comprises coupling at least one of a cellular telephone, a Universal Serial Bus drive, a personal digital assistant, and a portable media player to the computer.

4. The method of claim 1, further comprising at least one of adding an additional login entry, deleting an existing login entry and editing another existing login entry from the first database.

5. The method of claim 1, further comprising at least one of generating and updating a dictionary within the second database.

6. The method of claim 1, further comprising updating a password used to login to the remote host.

7. The method of claim 6, wherein updating the password comprises generating a current password with a current password generation schema, updating the password generation schema, generating a new password with the updated password generation schema, and submitting the current password and the new password to the remote host.

8. The method of claim 1, further comprising providing at least one computer system within the remote host, wherein the at least one computer system comprises an administrator application program stored thereon and comprising a plurality of databases.

9. The method of claim 8, further comprising coupling a second device to the at least one computer system to allow for monitoring of the first device, the first database, the second database, the plurality of databases and any communication lines between the client application program and the administrator application program.

10. The method of claim 9, further comprising coupling a third device to the at least one computer system to allow for modification of the first device, the first database, the second database, the second device, and the plurality of databases.

11. The method of claim 9, wherein updating the password comprises updating the password generation schema within the first database and the plurality of databases.

12. A computer security system, comprising:
at least one computer configured to be operably coupled to a remote network;
at least one client application program, a first database, and a second database stored on a first client device, the computer, a server within a device management entity, or combinations
thereof, wherein the at least one client application program is configured to dynamically generate a password; and
the first client device configured to be operably coupled to the at least one computer, wherein the at least one client device is further configured to enable use of the at least one client application program upon completion of an authentication process; and
at least one computer system within the remote network and configured to receive a username and password from the at least one computer.

13. The computer security system of claim 12, wherein the first client device comprises a wireless device configured to be operably coupled to the at least one computer with at least one of a wireless technology, a Bluetooth® technology, a Wi-Fi technology, and a WiMAX technology.

14. The computer security system of claim 13, wherein the wireless device comprises at least one of a cellular telephone, a Universal Serial Bus drive, a personal digital assistant, and a portable media player.

15. The computer security system of claim 12, wherein the at least one application program is further configured to dynamically generate a password using a password generation schema corresponding to the remote network.

16. The computer security system of claim 15, wherein the at least one client application program is further configured to attempt a login to the remote network using the dynamically generated password.

17. The computer security system of claim 12, wherein the at least one client application program is further configured to update a password stored on the at least one computer system by updating a password generation schema corresponding to the remote network.

18. The computer security system of claim 12, wherein the first database includes a login scripts database comprising at least one login entry pertaining to the remote network, wherein each login entry of the at least one comprises at least one of a password generation schema, a desired frequency of password change, and a date and time of last login.

19. The computer security system of claim 12, wherein the second database includes a variable database comprising a plurality of entries, each entry of the plurality comprising at least one of a word, a number, and a picture.

20. The computer security system of claim 12, wherein the at least one client device is configured to operate in at least one a global mode and a local mode.

21. The computer security system of claim 12, wherein the at least one client device is configured to deactivate upon a number of unsuccessful login attempts.

22. A computer network security system, comprising:
at least one computer configured to be operably coupled to a remote network;
at least a client application program, a first database, and a second database stored on a first client device, the computer, a server within a device management entity, or combinations thereof, wherein the at least one client application program is configured to dynamically generate a password; and
the at least one client device configured to be operably coupled to the at least one computer, wherein the at least one client device is further configured to enable use of the at least one client application program upon completion of an authentication process;
at least one computer system within the remote network and configured to receive a username and password from the at least one client application program, wherein at least one computer system of the plurality comprises an administrator application program stored thereon and including a plurality of databases;
a second device configured to be operably coupled to the at least one computer system and configured to allow for the monitoring of the at least one device, first database, the second database, the plurality of databases, and any communication links between the at least one client application program and the administrator application program; and
a third device configured to be operably coupled to the at least one computer system and configured to allow for modification of the at least one device, the second device, the first database, the second database, and the plurality of databases.

23. The computer network security system of claim 22, wherein at least one of the second device, the third device, and the at least one client device comprises a wireless device configured to be operably coupled to the at least one computer with at least one of a wireless technology, a Bluetooth® technology, a Wi-Fi technology, and a WiMAX technology.

24. The computer network security system of claim 23, wherein the wireless device comprises at least one of a cellular telephone, a Universal Serial Bus drive, a personal digital assistant, and a portable media player.

25. The computer network security system of claim 22, wherein the at least one application program is further configured to dynamically generate a password using a password generation schema corresponding to the remote network.

26. The computer network security system of claim 25, wherein the at least one client application program is further configured to attempt a login to the at least one computer system using the dynamically generated password.

27. The computer network security system of claim 22, wherein the at least one client application program is further configured to update a password stored on the at least one computer system by updating a password generation schema corresponding to the remote network.

28. The computer network security system of claim 22, wherein the first database includes a login scripts database comprising at least one login entry pertaining to the remote network, wherein each login entry of the at least one comprises at least one of a password generation schema, a desired frequency of password change, and a date and time of last login.

29. The computer network security system of claim 22, wherein the second database includes a variable database includes a plurality of entries, each entry of the plurality comprising at least one of a word, a number, and a picture.

30. The computer network security system of claim 22, wherein the at least one client device is configured to operate in at least one a global mode and a local mode.

31. The computer network security system of claim 22, wherein the at least one client device is configured to deactivate upon a number of unsuccessful login attempts.

32. A method of generating a password, comprising:
selecting an entry from a database;
selecting randomly a plurality of characters from the entry;
modifying at least one selected character of the plurality; and
generating at least a portion of a password from the plurality of selected characters.

33. The method of claim 32, further comprising:
selecting at least one additional entry from the database;
selecting randomly another plurality of characters from the at least one additional entry;
modifying at least one selected character of the another plurality; and
generating another portion of the password from the another plurality of selected characters.

34. The method of claim 33, wherein selecting at least one additional entry from the database comprises selecting up to ten entries from the database.

35. The method of claim 33, wherein the generated password may comprise up to sixty-four (64) characters.

36. The method of claim 32, wherein selecting an entry from a database comprises selecting an entry from a database comprising up to one thousand entries.

37. The method claim 32, wherein selecting an entry from a database comprises selecting an entry randomly.

38. The method of generating a password of claim 32, wherein selecting randomly a plurality of characters from the selected entry comprises selecting up to six characters from the selected entry.

39. The method of generating a password of claim 32, wherein modifying at least one character comprises performing a bit operation on the at least one character, wherein the bit operation comprises at least one of a shift operator and a bitwise operator.

40. A computer-readable media storing instructions that when executed by a processor cause the processor to perform instructions for generating a password, the instructions comprising:
selecting an entry from a database;
selecting randomly a plurality of characters from the entry;
modifying at least one selected character of the plurality; and
generating at least a portion of a password from the plurality of selected characters.

41. The computer-readable media of claim 40, further comprising:
selecting at least one additional entry from the database;
selecting randomly another plurality of characters from the at least one additional entry;
modifying at least one selected character of the another plurality; and
generating another portion of the password from the another plurality of selected characters.

42. The computer-readable media of claim 41, wherein selecting at least one additional entry from the database comprises selecting up to ten entries from the database.

43. The computer-readable media of claim 41, wherein the generated password may comprise up to sixty-four (64) characters.

44. The computer-readable media of claim 40, wherein selecting an entry from a database comprises selecting an entry from a database comprising up to one thousand entries.

45. The computer-readable media of claim 40, wherein selecting an entry from a database comprises selecting an entry randomly.

46. The computer-readable media of generating a password of claim 40, wherein selecting randomly a plurality of characters from the selected entry comprises selecting up to six characters from the selected entry.

47. The computer-readable media of generating a password of claim 40, wherein modifying at least one character comprises performing a bit operation on the at least one character, wherein the bit operation comprises at least one of a shift operator and a bitwise operator.
